(19) United States
(12) Patent Application Publication
(10) Pub. No.: US 2009/0096918 A1
(43) Pub. Date: Apr. 16, 2009

(54) Protected Security Monitoring Box

(75) Inventor: Ray Montelongo, Rockford, IL (US)

Correspondence Address: REINHART BOERNER VAN DEUREN P.C., 2215 PERRYGREEN WAY, ROCKFORD, IL, 61107, US

(73) Assignee: SecureCore, LLC, Rockford, IL (US)

(21) Appl. No.: 11/871,421

(22) Filed: Oct. 12, 2007

(51) Int. Cl. H04N 5/225

(52) U.S. Cl. 348/375; 348/151; 396/427

(57) ABSTRACT

A security monitoring apparatus including a security monitoring enclosure, a carousel, and a camera bracket is provided. The security monitoring enclosure has a bottom wall with an aperture passing therethrough. The carousel is rotatably mounted on the bottom wall for rotation over the aperture and, therefore, rotatable relative to the bottom wall of the security monitoring enclosure. The camera bracket is carried by the carousel and configured to secure a camera therein. The security monitoring apparatus may also include an environmental control unit regulating the environment within an internal compartment of the monitoring enclosure and/or a pole mounting apparatus configured to receive and engage with a pole.

### FIELD OF THE INVENTION

This invention generally relates to housings for a monitoring devices and, more particularly, to a housing for security or surveillance camera.

### BACKGROUND OF THE INVENTION

Surveillance cameras are widely used for security and monitoring purposes. In some circumstances, the surveillance cameras are enclosed within a housing such as disclosed in U.S. Pat. Nos. 6,735,382, 6,735,369, 6,354,749, and 5,852,754.

These housings generally shelter the surveillance camera from the elements, protect the camera from vandalism, conceal the camera from view to prevent distracting from the aesthetic quality of an area, and the like. This disclosure is generally directed to these housings for surveillance cameras.

### BRIEF SUMMARY OF THE INVENTION

In one aspect, a security monitoring apparatus including a security monitoring enclosure, a carousel, and a camera bracket is provided. The security monitoring enclosure has a bottom wall with an aperture passing therethrough. The carousel is rotatably mounted on the bottom wall for rotation over the aperture. The carousel is rotatable relative to the bottom wall of the security monitoring enclosure. The camera bracket is carried by the carousel and configured to secure a camera therein.

In another aspect, a security monitoring apparatus including a security monitoring enclosure, mounting structure, and an environmental control unit is provided. The security monitoring enclosure defines an internal compartment and has a vented region. The mounting structure is for security monitoring equipment disposed within the security monitoring enclosure. The environmental control unit communicates with the vented region and regulates the environment within the internal compartment of the monitoring enclosure.

In yet another aspect, a monitoring apparatus for mounting to a pole is provided. The monitoring apparatus includes a security monitoring enclosure having a side wall and a pole mounting apparatus secured to the side wall of the security monitoring enclosure. The pole mounting apparatus includes a plurality of mounting brackets linked together by a plurality of bars. The mounting brackets have exteriorly-facing grooves and are configured to receive and engage with the pole.

Other embodiments of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a front perspective view of an exemplary embodiment of a security monitoring apparatus in accordance with the teachings of the present invention;

FIG. 2 is a front perspective view of the security monitoring apparatus of FIG. 1 from another vantage point;

FIG. 3 is an embodiment of the security monitoring apparatus of FIG. 1 having a portion of an environmental control unit externally exposed;

FIG. 4 is a an embodiment of the security monitoring apparatus of FIG. 1 having a vented region;

FIG. 5 is a side perspective view of a bottom wall of the security monitoring apparatus of FIG. 1;

FIG. 6 is a side perspective view of the security monitoring apparatus of FIG. 1;

FIG. 7 is top perspective view of the bottom wall of FIG. 5;

FIG. 8 is partial cross section of the bottom wall of FIG. 5;

FIG. 9 is a rear perspective view of the security monitoring apparatus of FIG. 1 from another vantage point; and

FIG. 10 is a rear perspective view of the security monitoring apparatus of FIG. 1 from another vantage point.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

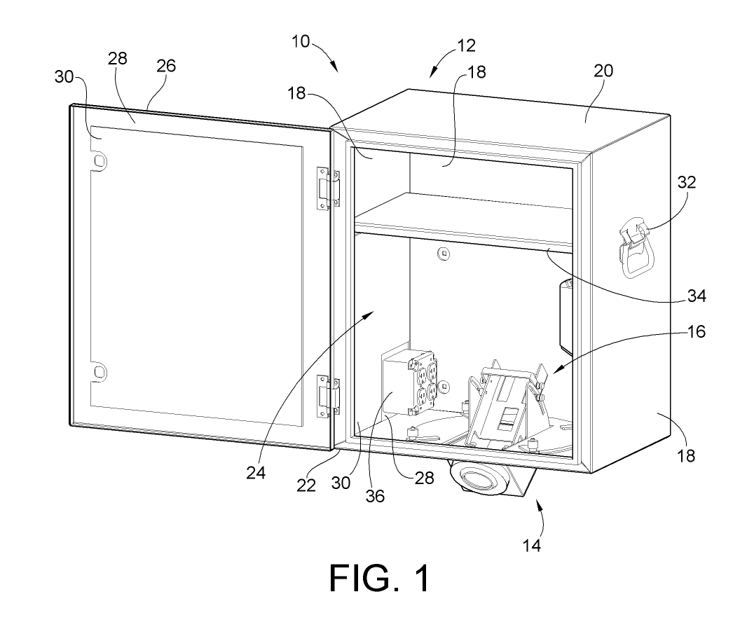

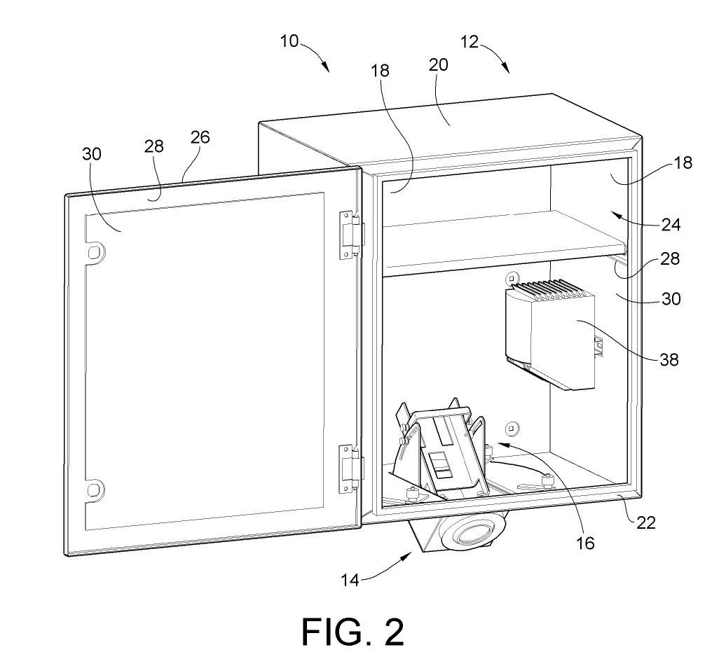

Referring to FIGS. 1 and 2, a security monitoring apparatus 10 is illustrated. As will be more fully explained below, the security monitoring apparatus 10 provides a suitable environment for a surveillance or security camera, resists ballistic attacks, and easily and conveniently mounts to a pole or similar structure. As shown, the security monitoring apparatus 10 includes a security monitoring enclosure 12, a carousel 14, and a camera bracket 16.

While the security monitoring enclosure 12 may have a variety of suitable shapes, sizes and configurations, the security monitoring enclosure 12 in the illustrated embodiment of FIGS. 1 and 2 has a generally rectangular shape. As such, the security monitoring enclosure 12 includes several side walls 18 bounded above and below by a top wall 20 and a bottom wall 22, respectively. Along with the top and bottom walls 20, 22, the side walls 18 form an internal compartment 24. The internal compartment 24 may be accessed or closed using a hinged door 26 secured to one of the side walls 18. In alternative embodiments, the door 26 may also be suitably attached to the bottom wall 22 or the top wall 20. The door 26 may include any of a variety of suitable locking mechanisms to prevent unauthorized entry into the internal compartment 24.

In the illustrated embodiment of FIGS. 1 and 2, each of the side, top, and bottom walls 18, 20, 22 and the door 26 are formed from an outer layer 28 of metal (e.g., steel, stainless steel, etc.) and an internal layer 30 of bullet resistant material (e.g., bullet resistant fiberglass, ceramic tile, etc.). Therefore, the security monitoring enclosure 12 is able to resist ballistic missiles (e.g., bullets), vandalism, and the like. In the illustrated embodiment of FIGS. 1 and 2, the internal layer 30 is secured to the outer layer 28 with a suitable adhesive and is formed from ARMORCORE™ marketed by Waco Composites, Ltd. If desired, seal-promoting materials (e.g., gaskets, sealants, etc.) may be used within or upon the security monitoring enclosure 12 to inhibit or prevent the elements (e.g., snow, rain, wind, etc.), contaminants or debris, and insects from gaining access to or entering the internal compartment 24.

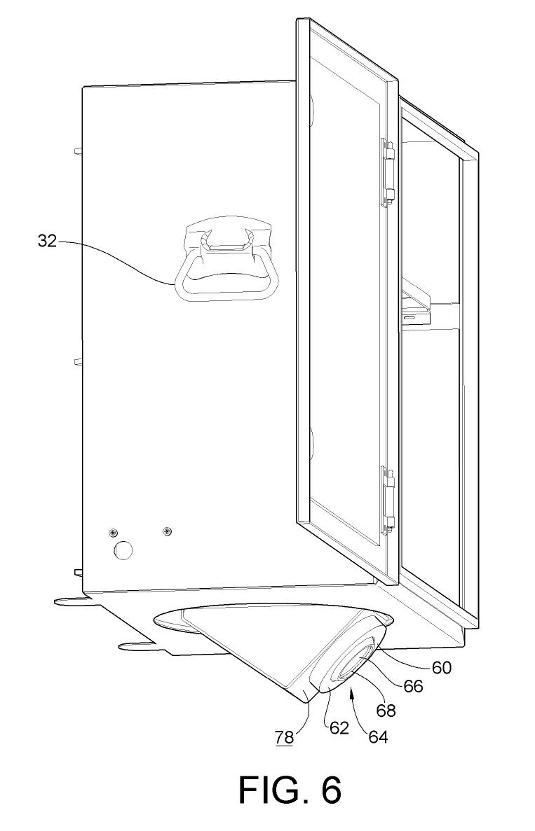

As shown in FIGS. 1 and 6, two of the side walls 18 opposing each other support a pair of handles 32. The handles 32 permit the security monitoring enclosure 12 to be easily grasped and lifted. Despite the location shown, the handles 32 may be otherwise disposed on or about the security monitoring enclosure 12 in a variety of different places. For example, a single handle 32 may be suitably attached to the top wall 20.

In the illustrated embodiment of FIGS. 1 and 2, the internal compartment 24 of the security monitoring enclosure 12 includes a shelf 34 extending horizontally (as oriented in FIG. 1) between opposing side walls 18. Ends of the shelf 34 extend through apertures in the internal layer 30 of the side walls 18 and are affixed to the outer layer 28 by shelf brackets. Even so, if additional support is needed, the shelf 34 may be secured in other locations and by further equipment or arrangements. The shelf 34 is generally used to support and store surveillance and monitoring equipment (e.g., walkie-talkies, camera parts and accessories, etc.) within the security monitoring enclosure 12.

As shown in FIG. 1, the internal compartment 24 of the security monitoring enclosure 12 also includes an electrical receptacle 36. The electrical receptacle 36 is electrically coupled to an electrical source (not shown) and provides, for example, four standard outlets having one hundred and ten volts (110 V) at about either fifty or sixty hertz. If desired, other outlet configurations providing other voltages may also be suitably used.

Referring now to FIG. 2, the internal compartment 24 of the security monitoring enclosure 12 also includes an environmental control unit 38. The environmental control unit 38 is secured to the outer layer 28 of the security monitoring enclosure 12 by a bracket passing through an aperture in the internal layer 30. Depending on the external climate or environment where the security monitoring apparatus 10 is used, the environmental control unit 38 may be a heater, a fan, an air conditioner, a dehumidifier, or some combination of those devices.

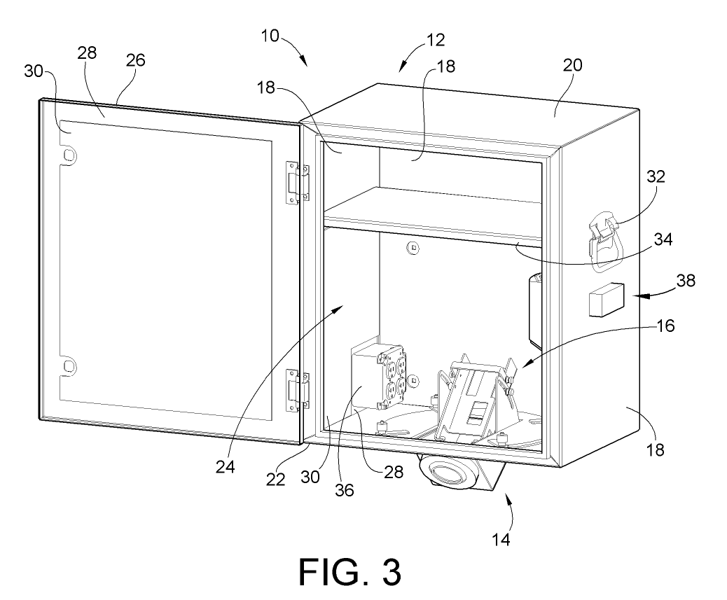

In the illustrated embodiment of FIG. 2, the environmental control unit 38 is depicted as a five-hundred fifty watt heater including a thermostat. The heater is in electrical communication with the electrical receptacle 36 and disposed entirely within the internal compartment 24. However, where the environmental control unit 38 is an air conditioner, components of the air conditioner (e.g., the compressor, the condenser coil and/or the expansion valve) may be disposed outside the internal compartment 24 as shown in FIG. 3.

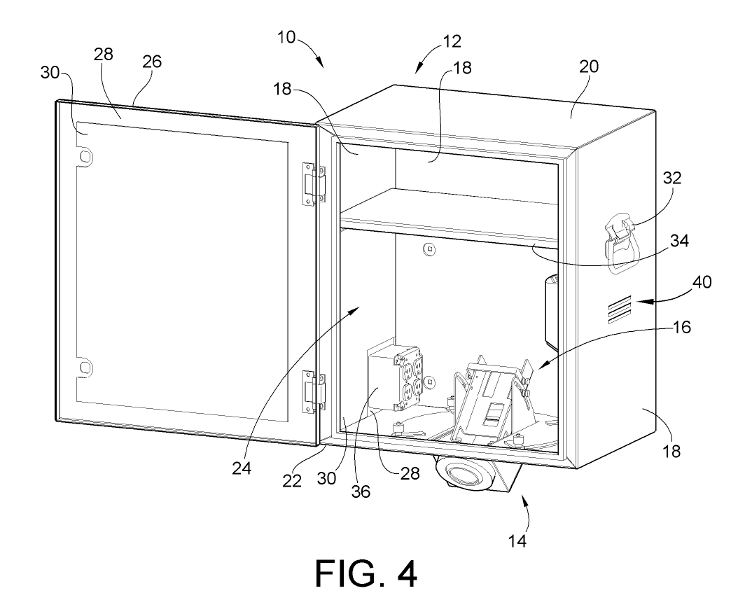

In addition to the above, where the environmental control unit 38 is either an air conditioner or fan, the environmental control unit may be exposed to the external environment through a vented region 40 as shown in FIG. 4. The vented region 40 generally passes through both the internal and outer layers 30, 28 of the side wall 18 adjacent the location of the environmental control unit 38 within the internal compartment 24. Therefore, the environmental control unit 38 is placed in fluid communication with the ambient air outside of the security monitoring enclosure 12. In this configuration, air may be vented out of, or drawn into, the internal compartment 24 through the vented region 40 as needed. In other embodiments, where the environmental control unit 38 is an air conditioner or dehumidifier, the security monitoring enclosure 12 may simply include an exit port (not shown) for expelling fluid from the internal cavity 24.

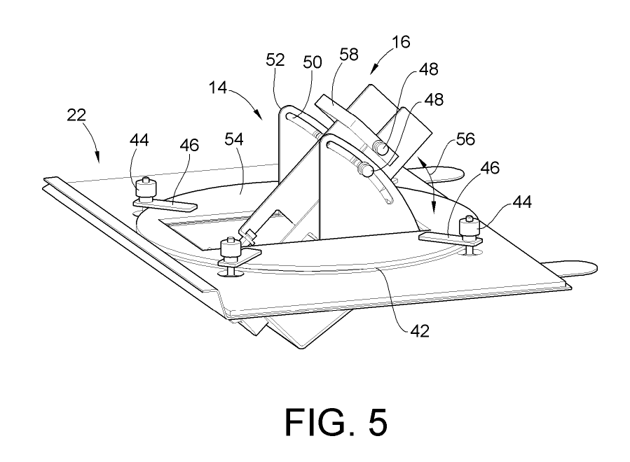

Referring now to FIG. 5, the bottom wall 22 has been extracted from the security monitoring enclosure 12 to better illustrate the carousel 14. As shown, the carousel 14 is generally mounted on the bottom wall 22 over an aperture 42 passing therethrough. Indeed, the aperture 42 is generally sized and dimensioned to correspond to the carousel 14. In the illustrated embodiment of FIG. 5, the aperture 42 and the carousel 14 adjacent the aperture have a circular periphery. With this configuration, the carousel 14 is rotatably mounted on the bottom wall 22 for rotation over the aperture 42. In addition, a standard or conventionally sized downwardly-facing security dome such as, for example, the lower dome of U.S. Pat. No. 5,852,754, may be suitably interchanged with the carousel 14 in the bottom wall 22 when the carousel is removed.

To facilitate the interchangeability of the carousel 14, thumb screws 44 and hold down plates 46 are provided. By rotating the top portion of each thumb screw 44 sufficiently upwardly, the hold down plates 46 disengage from contact with the carousel 14 and may be turned outwardly such that they are no longer disposed over the carousel as shown in FIG. 5. With the hold down plates 46 in this orientation, the carousel 14 may be lifted upwardly out of the bottom wall 22 leaving the aperture unfilled. Thereafter, a typical security dome, as noted above, may be lowered into the aperture 42. Like the carousel 14, the security dome is held in place by positioning the hold down plates 46 over the security dome and tightening the thumb screws 44.

Still referring to FIG. 5, the hold down screws 44 and thumb plates 46 also allow the carousel 14 to be selectively rotated relative to the bottom wall 22 and maintained in that position. By turning the thumb screws 44 to reduce the pressure of the hold down plates 46 on the carousel 14, the carousel may be rotated into any desired position. When that position is achieved, the thumb screws 44 are rotated to increase the pressure of the hold down plates 46 on the carousel 14. This clamps the carousel in place. The carousel 14 in the illustrated embodiment of FIG. 5 may be rotated a full three hundred and sixty degrees.

As an alternative to the method of rotating the camera noted above, a motor (not shown) may be used to rotate the carousel 14 in lieu of manually rotating the carousel using the thumb screws 44 and hold down plates 46. In such an embodiment, the motor is situated within the internal compartment 24 of the security monitoring enclosure 12. If the motor is an electric motor, the motor may be electrically coupled to an electrical power source via the electrical receptacle 36 (FIG. 1). In addition to the motor, other components such as, for example, gears and a gear chain may be included and employed to rotate the carousel 14.

As shown in FIG. 5, the camera bracket 16, which is mounted in or on the carousel 14, is sized and dimensioned to hold a conventional fixed position camera that has, for example, pan and zoom features. To tilt the camera, an additional set of thumbs screws 48 are utilized. These thumb screws 48 pass through arcuate slots 50 in vertical walls 52 projecting up from a base plate 54 of the carousel 14. The thumb screws 48 releasably clamp against the vertical walls 52 to maintain the camera bracket 16 at a desired angle 56 relative to the bottom wall 22 of the security monitoring enclosure 12. To adjust the angle 56 of the camera bracket 16, the thumb screws are rotated away from the vertical wall 52, moved through the slots 50 to either increase or decrease the angle 56 of the camera bracket 16 relative to the bottom wall 22, and then rotated toward the vertical wall to once again clamp the camera bracket in place.

In addition to the thumb screws 48 traveling in the slots 50, further thumb screws 48 are employed to hold a C-clamp 58 of the camera bracket 16 in place. The C-clamp 58 functions to prevent the fixed position camera from moving when disposed in the camera bracket 16. However, should the camera need to be removed, the thumb screws 48 may be rotated to either loosen or permit removal of the C-clamp 58.

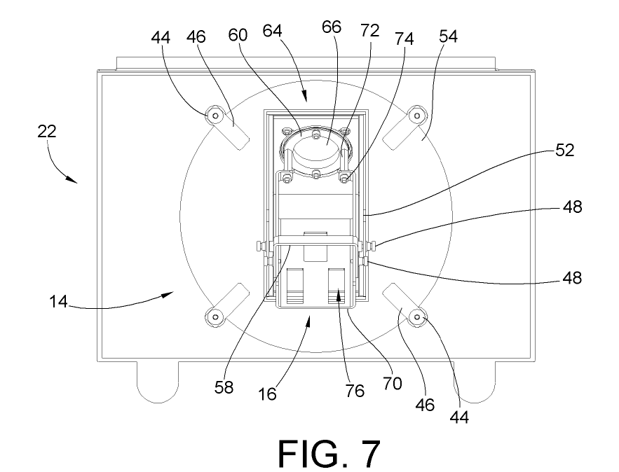

Referring now to FIGS. 6 and 7, a ball 60 of the camera bracket 16 and a cup 62 of the carousel 14 interact with each other to form a pivot joint 64. As the angle 56 (a.k.a., tilt) of the camera bracket 16 is adjusted relative to the bottom wall 22, the ball 60 moves within the cup 62. Therefore, through the pivot joint 64, the camera bracket 16 is pivotable relative to the carousel 14. As shown, the cup 62 of the carousel 14 and the ball 60 of the camera bracket 16 extend outwardly beyond the bottom wall 22 of the security monitoring enclosure 12. Indeed, in the orientation shown in FIG. 6, the pivot joint 64 projects downwardly below the bottom wall 22. To protect the front portion of the camera, a window 66 covers a ball aperture 68 passing through the ball 60. In the illustrated embodiment of FIG. 6, the window 66 is formed from a polycarbonate resin thermoplastic marketed as LEXAN® by General Electric.

In the illustrated embodiment of FIG. 7, in addition to the ball 60, the camera bracket 16 also includes a camera tray 70 secured to one end of a set of stand-offs 72 by threaded bolts 74. The camera tray 70 is generally channel-shaped and has several apertures 76 formed therethrough. The ball 60 of the camera bracket 16 is attached to an opposing end of the set of stand-offs 72. A set of threaded bolts 74 are used to secure the cup 62 (FIG. 6) against the external surface 78 of the carousel 14.

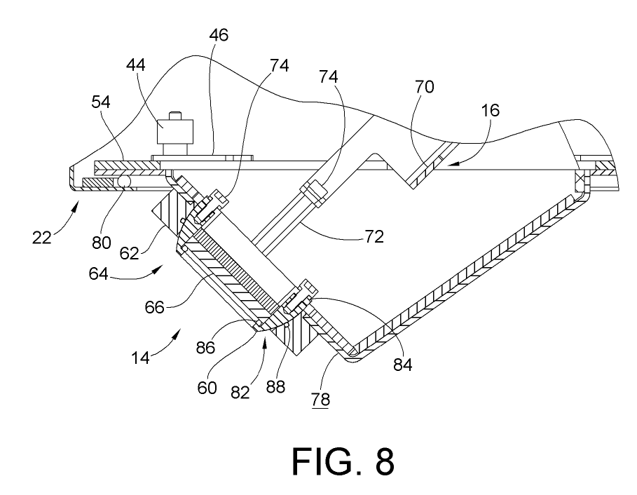

As depicted in FIG. 8, the interaction of the pivot joint 64 and the structure of the security monitoring enclosure 12 where the ball 60 and cup 62 reside is shown in further detail. As shown, the carousel 14 rests on an O-ring 80 interposed between the carousel and the bottom wall 22. Also, the ball 60 is generally nested within and fills a cup aperture 82 extending through the cup 62. A set of threaded bolts 74 are used to bias a retaining ring 84 against the window 66. When the threaded bolts 74 are sufficiently rotated, the retaining ring 84 presses the window 66 against an O-ring 86 held in place by the ball 60. A further O-ring 88 is interposed between the ball 60 and cup 62.

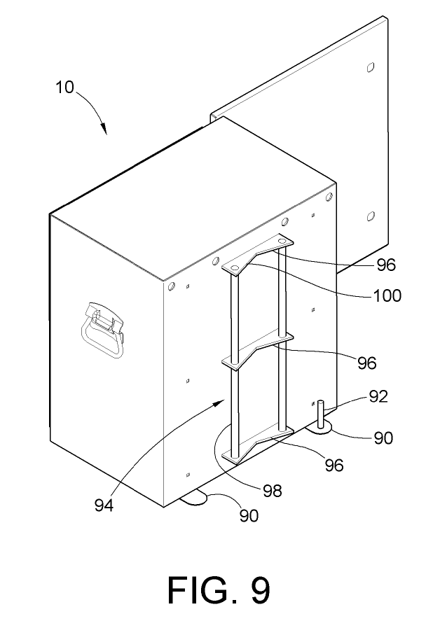

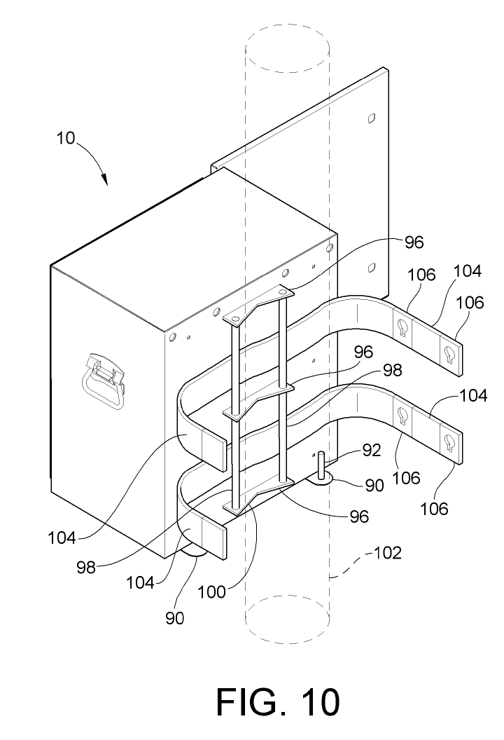

Referring now to FIGS. 9 and 10, the bottom wall 22 is depicted as having a pair of rearwardly-extending pedestals 90. These pedestals 90 are, in the illustrated embodiment of FIGS. 9 and 10, used to support an antennae 92 (e.g., a wireless antennae). As shown, the mast of the antennae 92 rests upon and is secured to one of the pedestals 90. Although not shown, the internal compartment 24 of the security monitoring enclosure 12 may be outfitted with wireless transmission equipment such as, for example, a wireless transmitter and/or receiver to accommodate wireless communication. If desired, the internal compartment 24 may also include various components for wired communication such as, for example, a telephone jack, a cable hook-up, and a universal serial bus port.

Still referring to FIGS. 9 and 10, a pole mounting apparatus 94 is secured the rearward-facing side wall 18 of the security monitoring enclosure 12. The pole mounting apparatus 94 includes mounting brackets 96 linked together by bars 98. The mounting brackets 96 have outwardly-facing grooves 100 and are configured to receive and engage with a pole 102 (shown in dashed lines). In the illustrated embodiment, the bars 98 are generally parallel to, and offset from, the side wall 18 by the mounting brackets 96.

The pole mounting apparatus 94 also includes one or more connecting members, which are illustrated in FIG. 10 as straps 104. These straps 104 are generally flexible in nature, adjustable in length, and formed from a durable material such as stainless steel. When in use, the straps 104 pass between the bars 98 and the side wall 18 and extend around the pole 102. When collectively wrapped around the pole 102 and the bars 98, the straps 104 are able to hold the security monitoring apparatus 10 aloft or in its desired position. To prevent theft, vandalism or slippage of the security monitoring enclosure 12 relative to the pole, the ends or some other portion of the straps 104 may include a releasably lockable fastening device 106.

From the foregoing, those skilled in the art will recognize the security monitoring apparatus 10 provides a suitable environment for a surveillance or security camera, resists ballistic attacks, and easily and conveniently mounts to a pole or similar structure.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A security monitoring apparatus comprising:
a security monitoring enclosure having a bottom wall, the bottom wall having an aperture passing therethrough;
a carousel rotatably mounted on the bottom wall for rotation over the aperture, the carousel rotatable relative to the bottom wall of the security monitoring enclosure; and
a camera bracket carried by the carousel, the camera bracket configured to secure a camera therein.

2. The security monitoring apparatus of claim 1, further comprising a pivot joint between the camera bracket and the carousel such that the camera bracket is pivotable relative to the carousel.

3. The security monitoring apparatus of claim 2, wherein the pivot joint is formed by a ball of the camera bracket and a cup of the carousel.

4. The security monitoring apparatus of claim 3, further comprising a plurality of thumb screws and a plurality of hold down plates, the hold down plates clamping the carousel in place relative to the bottom wall of the security monitoring enclosure when the thumb screws are rotated.

5. The security monitoring apparatus of claim 4, further comprising a plurality of additional thumb screws, the additional thumb screws passing through slots in walls of the camera bracket and releasably clamping against the walls to maintain the camera bracket at a desired angle relative to the bottom wall of the security monitoring enclosure.

6. The security monitoring apparatus of claim 5, wherein two of the additional thumb screws are employed to support a camera clamp disposed over the camera bracket.

7. The security monitoring apparatus of claim 3, wherein the cup of the carousel and the ball of the camera bracket extend outwardly beyond the bottom wall of the security monitoring enclosure.

8. The security monitoring apparatus of claim 3, wherein a polycarbonate resin thermoplastic window covers a ball aperture passing through the ball and the camera bracket is configured to receive a fixed position camera.

9. The security monitoring apparatus of claim 1, wherein the security monitoring enclosure includes an outer layer of steel surrounding an internal layer of bullet resistant fiberglass.

10. The security monitoring apparatus of claim 1, wherein the security monitoring enclosure includes an environmental control device and an electrical receptacle, the environmental control device and the electrical receptacle disposed inside the security monitoring enclosure.

11. The security monitoring apparatus of claim 1, wherein the security monitoring enclosure includes a horizontally-extending shelf within the security monitoring enclosure and a handle attached to an outer surface of the security monitoring enclosure.

12. The security monitoring apparatus of claim 1, further comprising an electrical receptacle and electrical heater coupled to the electrical receptacle disposed within the security monitoring enclosure.

13. A security monitoring apparatus comprising:
a security monitoring enclosure defining an internal compartment and having a vented region;
mounting structure for security monitoring equipment disposed within the security monitoring enclosure; and
an environmental control unit communicating with the vented region, the environmental control unit regulating the environment within the internal compartment of the monitoring enclosure.

14. The monitoring apparatus of claim 13, wherein the environmental control unit is an air conditioner, a portion of the air conditioner disposed outside the security monitoring disclosure.

15. A monitoring apparatus for mounting to a pole, comprising:
a security monitoring enclosure having a side wall; and
a pole mounting apparatus secured to the side wall of the security monitoring enclosure, the pole mounting apparatus comprising a plurality of mounting brackets linked together by a plurality of bars, the mounting brackets having exteriorly-facing grooves and configured to receive and engage with the pole.

16. The monitoring apparatus of claim 15, wherein the bars are generally parallel to and offset from the side wall by the mounting brackets.

17. The monitoring apparatus of claim 16, wherein the pole mounting apparatus includes a plurality of connecting members, the connecting members passing between the bars and the side wall and configured to extend around the pole.

18. The monitoring apparatus of claim 17, wherein the connecting members are straps, free ends of the straps connectable to each other to prevent the security monitoring enclosure from moving relative to the pole.

19. The monitoring apparatus of claim 18, wherein the mounting brackets are generally parallel to, and spaced apart from, each other, and wherein the exterior-facing grooves of the mounting brackets includes a periphery forming an obtuse angle.

20. The monitoring apparatus of claim 19, wherein the security monitoring enclosure includes a carousel carrying a camera bracket, the carousel rotatable relative to a bottom wall of the security monitoring enclosure, and wherein the security monitoring enclosure includes an environmental control unit inside, and wherein the security monitoring enclosure further includes a bottom wall having a rearwardly-extending pedestal, the pedestal supporting a wireless antennae.
